(19) United States
(12) Patent Application Publication
(10) Pub. No.: US 2007/0156680 A1
(43) Pub. Date: Jul. 5, 2007

(54) Disconnected authoring of business definitions

(75) Inventors: Ian Tien, Seattle, WA (US); Chen-I Lim, Bellevue, WA (US); Corey Hulen, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/313,390

(22) Filed: Dec. 21, 2005

(51) Int. Cl. G06F 17/30

(52) U.S. Cl. 707/6

(57) ABSTRACT

Disconnected authoring of business scorecards is enabled. Subscribers are enabled to author scorecards adding new elements, removing existing elements, and modifying content and/or properties of existing elements while disconnected from a server application managing the scorecards. Upon transitioning to a reconnected phase, configuration data for modified elements is compared to the original configuration data and differences resolved. New configuration data for the elements is then created based on the resolved differences. Modifications may be accepted based on time of change, permission attribute of the subscriber, and the like. Modified elements may be flagged in the scorecard presentation.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Scorecards are used to provide detailed and summary analysis of KPI's and aggregated KPI's such as KPI groups, objectives, and the like. Scorecard calculation results may be presented to various subscribers based on their preference, data source, analysis choices, and the like. In an enterprise, a number of participants may interact with a business logic application employing scorecards. The participants may provide data, receive reports for portions or all of the evaluated performances, and configure or reconfigure performance evaluation metrics. Coordinating and synchronizing interactions of the participants and updating central information systems may present a burdensome task.

For example, business intelligence systems are typically implemented by consultants with appropriate skill sets who visit a client to create, configure, and install a business intelligence solution. One of the major challenges faced by such consultants is accessing the client's network when they are not on site or updating work done when network connection(s) are not established.

### SUMMARY

A comparison-based approach enables disconnected authoring of business definitions. Upon transitioning to a reconnected phase, configuration data for modified elements is compared to the original configuration data and any differences are resolved. Modifications may include adding new elements, removing existing elements, and modifying content and/or properties of existing elements during a disconnected phase. After differences are resolved depending on type of modification, new configuration data for the elements is created that is based on the resolved differences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a business logic application for disconnected authoring of business definitions may be executed;

FIG. 2 illustrates a system, where example embodiments of disconnected authoring of business definitions may be implemented;

FIG. 3 illustrates an example scorecard architecture according to embodiments;

FIG. 4 illustrates a screenshot of an example scorecard;

FIG. 5 is a conceptual diagram illustrating three phases of networked business logic application;

FIG. 6 illustrates example elements of a business logic application during the three phases of FIG. 5;

FIG. 7 illustrates a screenshot of an example business logic application user interface with workspace browser and KPI details summary; and

FIG. 8 illustrates a logic flow diagram of a process for disconnected authoring of business definitions in a business logic system.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

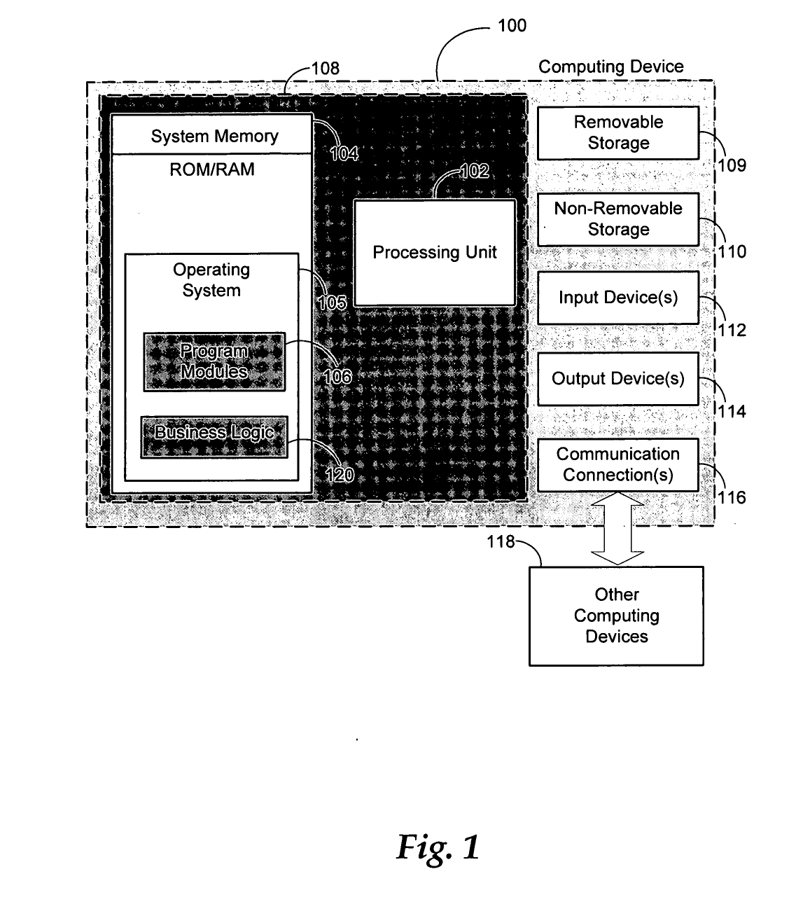

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105 and one or more program modules 106 working within operating system 105.

In addition to program modules 106, business logic application 120 may also be executed within operating system 105. Business logic application 120 may include a scorecard application or any similar application to manage business evaluation methods. Business logic application 120 may enable subscribers to author business definitions such as scorecards, KPI's, and other elements even when a client application is disconnected from a server application and synchronize the definitions when connection is reestablished.

To perform the actions described above, business logic application 120 may include and/or interact with other computing devices, applications, and application interfaces (APIs) residing in other applications.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

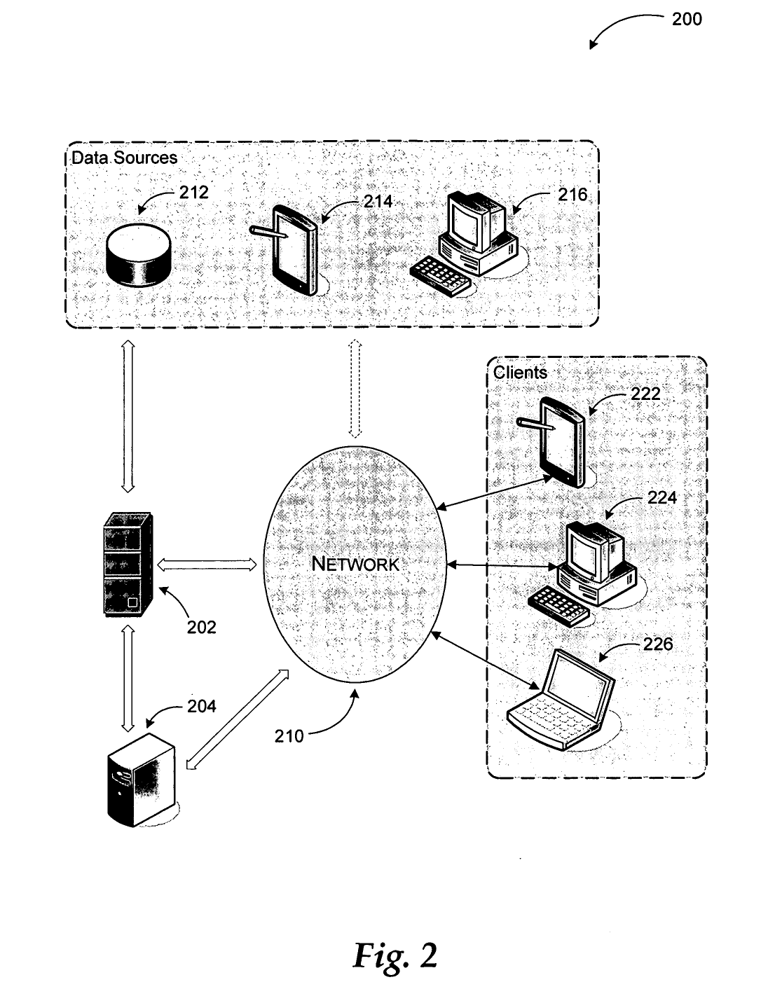

FIG. 2 illustrates system 200, where example embodiments of disconnected authoring of business definitions may be implemented. System 200 may comprise any topology of servers, clients, Internet service providers, and communication media. Also, system 200 may have a static or dynamic topology.

A business logic application may be run centrally on server 202 or in a distributed manner over several servers (e.g. servers 202 and 204) and/or client devices. Server 202 may include implementation of a number of information systems such as performance measures, business scorecards, and exception reporting. A number of organization-specific applications including, but not limited to, financial reporting, analysis, booking, marketing analysis, customer service, and manufacturing planning applications may also be configured, deployed, and shared in system 200. In addition, the business logic application may also be run in one or more client devices and information exchanged over network 210.

Data sources 212, 214, and 216 are examples of a number of data sources that may provide input to server 202. Additional data sources may include SQL servers, databases, non multi-dimensional data sources such as text files or EXCEL® sheets, multi-dimensional data source such as data cubes, and the like.

According to one embodiment, the business logic application running on server 202 is configured to receive modified configuration data associated with a scorecard element upon transitioning to a reconnected phase, compare the modified configuration data to an original configuration data associated with the scorecard element, and resolve differences between the modified configuration data and the original configuration data based on the comparison. The business logic application may then create new configuration data for the scorecard element based on the resolved differences. One or more client applications running on client devices 222, 224, and 226 are configured to provide a user interface for authoring the scorecard in a disconnected phase and provide the modified configuration data to the server application upon transitioning to the reconnected phase.

The business logic application and the client application(s) may maintain and exchange configuration data in form of versioned XML files. The business logic application may also be configured to issue an alert to selected subscribers when the original configuration information is updated based on the modified configuration information. In a scorecard presentation, a modification indicator for each modified scorecard element may be provided during the reconnected phase.

The client applications may save the modified configuration information automatically after a predetermined period, upon completion of the modification, or before transitioning to the reconnected phase.

Network 210 may be a secure network such as an enterprise network, or an unsecure network such as a wireless open network. Network 210 provides communication between the nodes described above. By way of example, and not limitation, network 210 may include wired media such as a wired network or direct-wired connection, and wireless media such as acoustic, RF, infrared and other wireless media.

Many other configurations of computing devices, applications, data sources, data distribution and analysis systems may be employed to implement a business logic application centrally managing updates to scorecard-based reports.

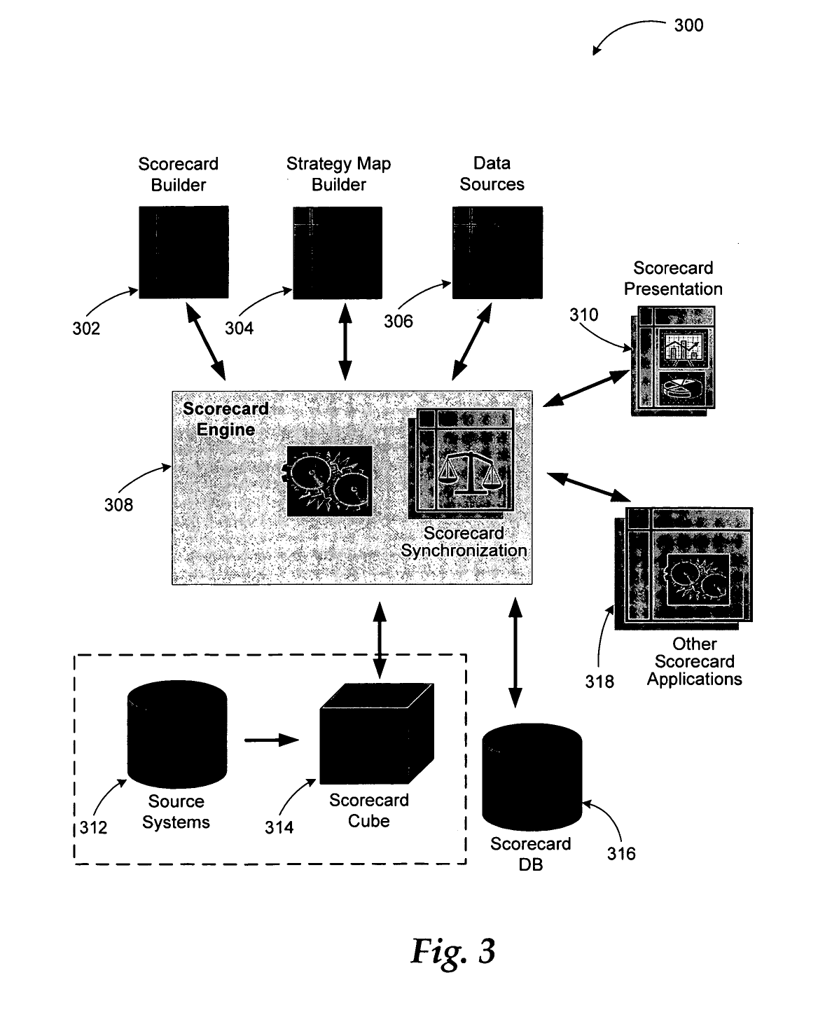

FIG. 3 illustrates example scorecard architecture 300. Scorecard architecture 300 may comprise any topology of processing systems, storage systems, source systems, and configuration systems. Scorecard architecture 300 may also have a static or dynamic topology.

Scorecards are a simple method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application that is arranged to evaluate performance metrics. Scorecard engine 308 may be loaded into a server, executed over a distributed network, executed in a client device, and the like.

In addition to performing scorecard calculation, scorecard engine may also perform scorecard synchronization tasks in a distributed implementation. As part of its scorecard synchronization tasks, scorecard engine 308 may receive information associated with changes to scorecard elements (authoring in disconnected phase) from other scorecard applications 318 and dynamically modify original configuration information associated with a scorecard in response to a modification of a business scorecard in a disconnected phase. The scorecard engine may then compare the modified configuration information to the original configuration information upon transitioning to a connected phase and resolve differences between the modified configuration information and the original configuration information based on the comparison. New configuration information is then created based on the resolved differences.

The configuration information may include a scorecard identifier; a business metrics identifier, such as a KPI identifier, a KPI group identifier, or an objective identifier; a data source identifier, or a status indicator. The configuration information may further include content associated with the scorecard and/or metadata associated with at least one of the elements of the scorecard.

In some embodiments, the differences may be resolved by assigning a most recent value for an element from one of the modified configuration information and the original configuration information to the corresponding element in the new configuration information. To resolve the differences, changes in the modified configuration information may be accepted based on a permission assigned to the subscriber performing the modification.

In other embodiments, the differences may be resolved by employing one of three processes: a create process, an exclude process, and an update process. The create process includes adding a new element from a subscriber workspace to the scorecard based on the modified configuration information. The exclude process includes removing an existing element of the scorecard based on the modified configuration information. The update process includes updating the content or the metadata associated with an existing element of the scorecard based on the modified configuration information.

The configuration information may be maintained and exchanged in a versioned extensible Mark-up Language (XML) file.

Data for evaluating various measures may be provided by a data source. The data source may include source systems 312, which provide data to a scorecard cube 314. Source systems 312 may include multi-dimensional databases such as an Online Analytical Processing (OLAP) database, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a Graphical User Interface (GUI), and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other Open Database Connectivity (ODBC)-accessible data source systems (e.g. Excel, text files, etc.). Data sources 306 may also define KPI mappings and other associated data.

Scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like. A user interface for scorecard presentation 310 may also include an overview of available scorecards for a subscriber to select from.

Other scorecard applications 318 may include any application that receives data associated with one or more scorecard from scorecard engine 308 and enables a subscriber to author the scorecard even in a disconnected phase. The data associated with the scorecard(s) may include content data and metadata. Other scorecard applications 318 may save the modified configuration information for elements authored in the disconnected phase automatically after a predetermined period, upon completion of the modification, or before transitioning to the reconnected phase. They may provide the saved modification information to scorecard engine 308 when reconnected.

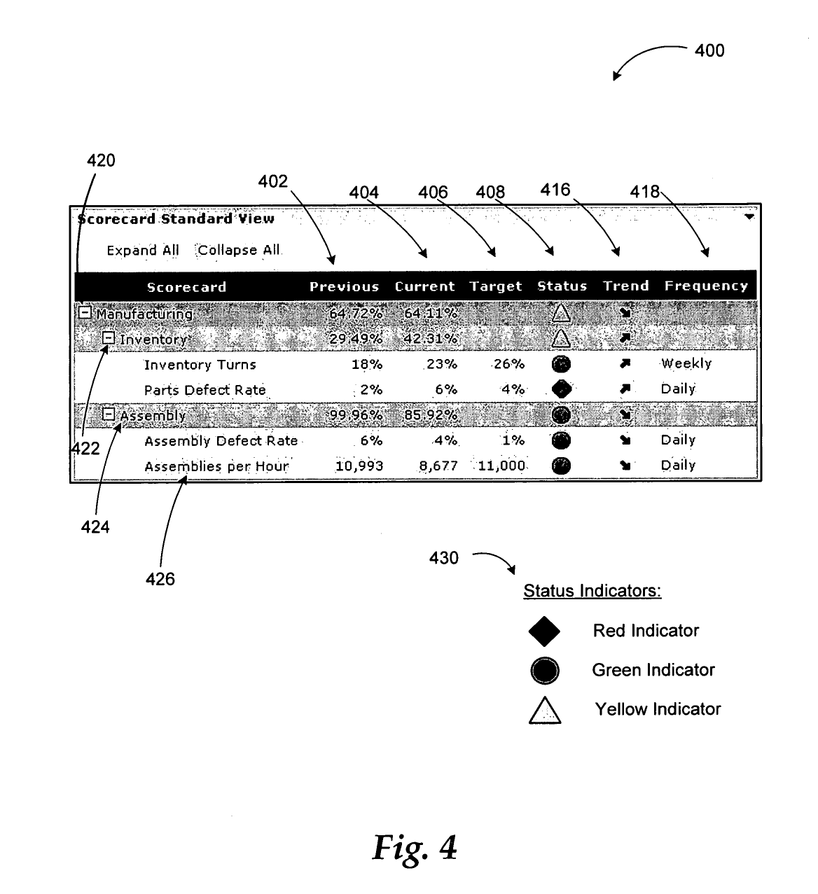

FIG. 4 illustrates a screenshot of an example scorecard. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. The shared use of KPI definition may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The trend arrows displayed in scorecard 400 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400 shows example elements perspective 420 “Manufacturing” with objectives 422 and 424 “Inventory” and “Assembly” (respectively) reporting to it. Second column 402 in scorecard 400 shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400. Target values may be retrieved from a database, entered by a user, and the like. Column 408 of scorecard 400 shows status indicators.

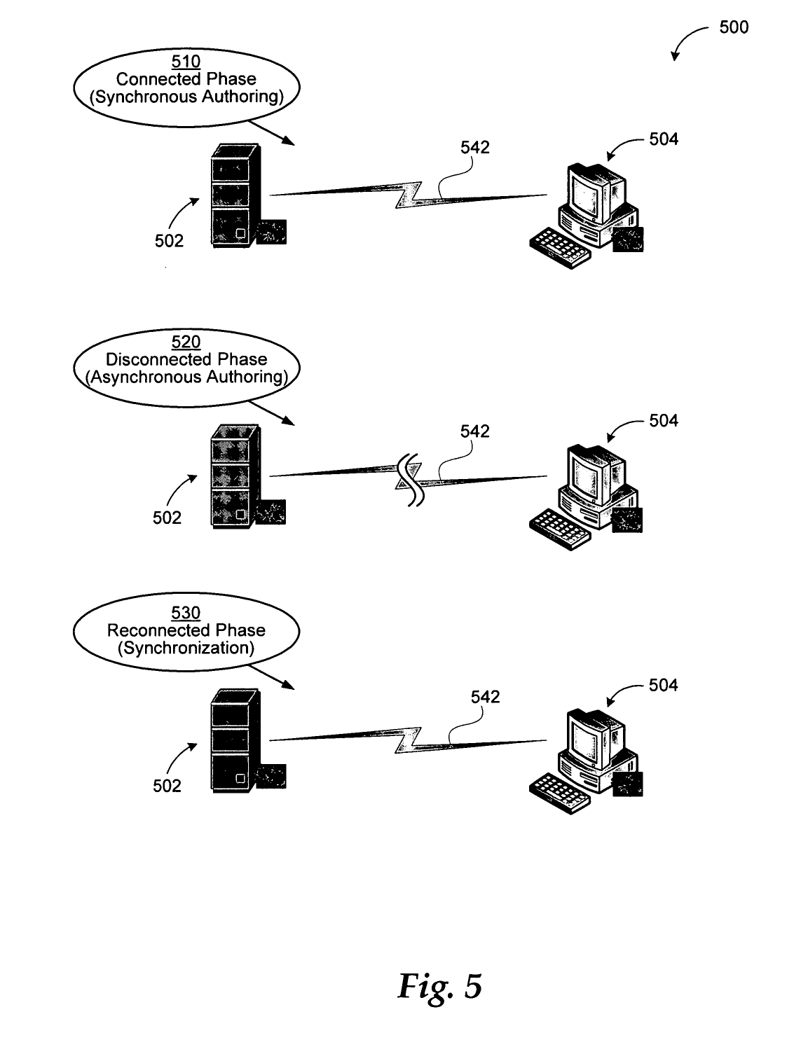

Status indicators 430 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands as described below in conjunction with FIG. 5.

Column 416 includes trend type arrows as explained above under KPI attributes. Column 418 shows another KPI attribute, frequency.

FIG. 5 includes conceptual diagram 500 illustrating three phases of networked business logic application. Diagram 500 includes connected phase 510, disconnected phase 520, and reconnected phase 530.

Server 502 may be any computing device running a business logic application that processes business scorecards. Client device 524 may run a separate business logic application that communicates with server 502 or provide remote access to the business logic application on server 502 to a subscriber. Server 502 and client device 524 may be in communication via communication medium 542. Communication medium 542 may include any network communication type described previously.

In connected phase 510, server 502 and client device 524 are in communication via communication medium 542. In this phase, scorecard authoring is typically performed synchronously. Any modifications by the subscriber using client device 524 are processed simultaneously by server 502. Acceptance of rejection of changes may depend on subscriber credentials, time of submittal, and the like.

In disconnected phase 520, the communication link between server 502 and client device 524 is broken. Thus, scorecard authoring is performed asynchronously. In some embodiments, server 502 may manage business logic application in conjunction with a plurality of client devices receiving authoring inputs for the scorecards handled by the business logic application. In such a scenario, not all client devices may be disconnected at the same time. Accordingly, some client devices may be in disconnected phase while others are still connected.

While in disconnected phase, the subscriber may continue to author one or more scorecards making changes to elements, removing or adding elements. Typically, new elements may only be added if they exist in the subscriber's workspace. Client device 524 may save modified configuration information associated with the scorecards automatically after a predetermined period, upon completion of the modification, or before transitioning to the reconnected phase.

In reconnected phase 530, client device 524 and server 502 are once again in communication over communication medium 542. Because changes may have been made in the preceding disconnected phase, server 502 may synchronize the scorecards before performing further actions and allowing the subscriber to author the scorecard(s) synchronously.

The synchronization process may include receiving the modified configuration information from client device 524, comparing the modified configuration information to an original configuration information, and resolving differences.

The differences may be resolved by employing one of three processes: a create process, an exclude process, and an update process. The create process includes adding a new element from a subscriber workspace to the scorecard based on the modified configuration information. The exclude process includes removing an existing element of the scorecard based on the modified configuration information. The update process includes updating the content or the metadata associated with an existing element of the scorecard based on the modified configuration information.

Once the differences are resolved, server 502 may create new configuration information for the scorecard(s) and use the new configuration information as basis for operations in reconnected phase 530.

In one embodiment, the configuration information may be maintained and exchanged by server 502 and client device 524 in a versioned eXtensible Mark-up Language (XML) file.

While system 500 illustrates a simplistic form of networked business logic implementation, embodiments are limited to these exemplary illustrations. A business logic application managing scorecards may be executed on a server, on a client device, on multiple devices in a distributed manner, and the like. As mentioned above, a plurality of remote devices and/or applications may be employed for disconnected authoring of scorecards and scorecard elements.

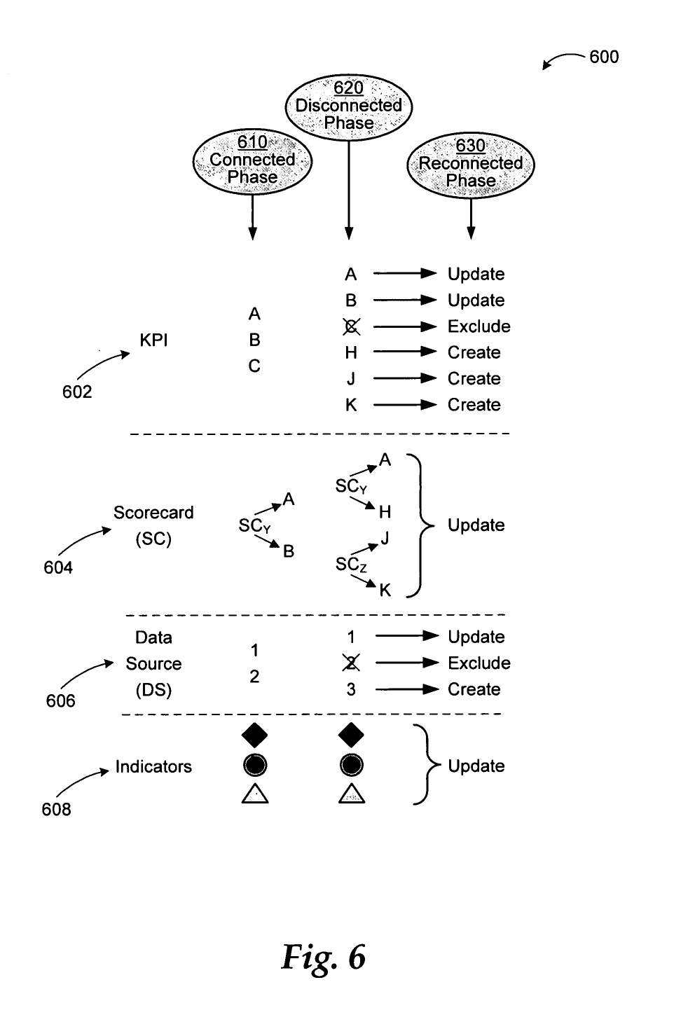

FIG. 6 illustrates diagram 600 of example elements of a business logic application during the three phases of FIG. 5. Diagram 600 includes four types of example elements that may be authored in a disconnected phase. These elements include KPI's 602, scorecards 604, data sources 606, and indicators 608.

For KPI's 602, three example KPI's, A, B, and C are listed in connected phase 610. In disconnected phase 620, a subscriber removes KPI C and adds new KPI's H, J, and K from his/her workspace. In reconnected phase 630, the actions for synchronization include: update for KPI's A and B, exclude for KPI C, create for KPI's H, J, and K. As described previously, these actions are performed by a scorecard engine updating content and properties for existing KPI's A and B, removing KPI C from the scorecard and recalculating the scorecard, and adding the new KPI's as specified by the subscriber.

For scorecards 604, two examples are given. Scorecard SC_{Y} has two KPI's reporting to it, A and B, in the connected phase. In the disconnected phase, SC_{Y} is modified such that new KPI H reports to SC_{Y} instead of existing KPI B. Another change in disconnected phase 620 is the addition of scorecard SC_{Z} with its reporting KPI's J and K. Because the KPI's have been already added, removed and updated in the previous step, all scorecards are update in reconnected phase 630 by the scorecard engine.

Data sources 606 are another type of business logic element that may be authored in a disconnected phase. Data sources are synchronized in a similar manner to KPI's. In the example diagram, data sources 1 and 2 exist in connected phase 610. In disconnected phase 620, data source 2 is removed and data source 3 is added. Accordingly, update, exclude, and create functions are executed for data sources 1, 2, and 3, respectively, in reconnected phase 630.

Indicators 608 are yet another type of scorecard element that may be authored in the disconnected phase. In the example, red, green, and yellow status indicators of a traffic light scheme are used in the connected phase. In disconnected phase 620, the same status indicators are used by the subscriber. However, status indicators of the scorecards may change due to KPI and content changes. Thus, status indicators are also updated in reconnected phase 630. Other indicator schemes may also be used without departing from a scope and spirit of the invention.

The synchronization actions described for reconnected phase 630 may depend on a number of factors as described previously. In a multiple subscriber system, the changes may be accepted or rejected by the scorecard engine based on which change was submitted most recently or a similar criterion. Subscriber credentials such as create/read/update/delete privileges may also be considered in accepting or rejecting changes.

Other elements, phases, structures, and transition methods may also be implemented using the principles described herein.

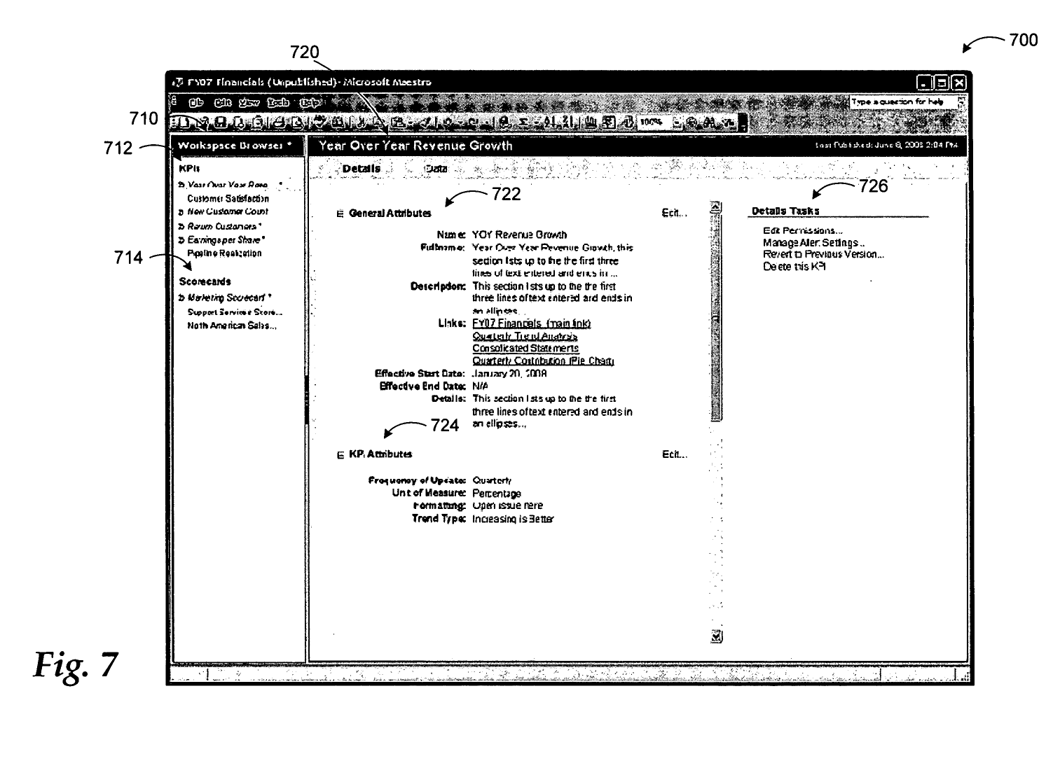

FIG. 7 illustrates screenshot 700 of an example business logic application user interface (UI) with workspace browser and KPI details summary. The UI in screenshot 700 includes workspace browser 710 and KPI details pane 720.

Workspace browser 710 provides a subscriber a listing of KPI's (712) and scorecards (714) available for authoring. A subscriber's permissions to author the available KPI's may depend on his/her credentials, assigned attributes, and the like. Thus, one subscriber may be allowed to author some aspects of the available KPI's and scorecards, while another subscriber may be allowed to modify other aspects of the available KPI's and scorecards.

KPI details pane 720 provides the subscriber detailed information on a KPI selected in workspace browser 710. In screenshot 700, “Year Over Year Revenue Growth” KPI is selected (highlighted) in workspace browser 710. Details for the “Year Over Year Revenue Growth” KPI shown in KPI details pane 720 include general attributes 722 (e.g. short name for the KPI, full name for the KPI, description, and related links) and KPI attributes (e.g. frequency of update, unit of measure, formatting, trend type, and the like). KPI details pane 720 further includes detail tasks portion 726, which provides the subscriber with links to tasks such as editing permissions, managing alert settings, reverting to a previous version, and the like.

As described previously, the subscriber may author specific KPI's or whole scorecards using a UI such as the UI shown in screenshot 700 even in a disconnected phase. Changes recorded in the disconnected phase may then be synchronized by a central scorecard engine in a reconnected phase.

Scorecard editing tools for disconnected authoring are not limited to the example described above. Other UI's with different layouts, elements, and styles may be implemented using the principles described herein.

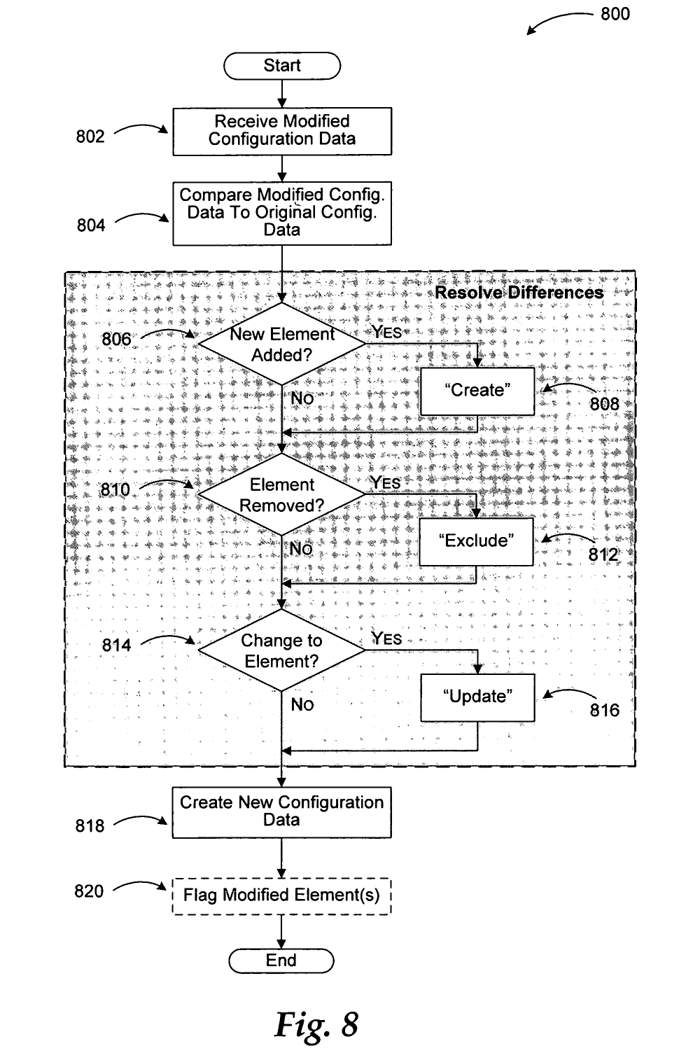

FIG. 8 illustrates a logic flow diagram of process 800 for disconnected authoring of business definitions in a business logic system. Process 800 may be implemented in a business logic application by a scorecard engine, such as scorecard engine 308 of FIG. 3.

Process 800 begins at operation 802, where modified configuration data is received from a client application. As described before, changes to elements of a scorecard may be made by a subscriber during a disconnected phase. Processing advances from operation 802 to operation 804.

At operation 804, the modified configuration data associated with the authored scorecard elements is compared to original configuration data. The configuration information may include a scorecard identifier; a business metrics identifier, such as a KPI identifier, a KPI group identifier, or an objective identifier; a data source identifier, or a status indicator. The configuration information may further include content associated with the scorecard and/or metadata associated with at least one of the elements of the scorecard. Processing moves next to a group of operations that are directed at resolving differences between the modified configuration data and the original configuration data.

At decision operation 806, a determination is made whether a new element is added. If a new element is added, a “create” process adds the new element within the structure of the scorecard at operation 808. If no element is added, or operation 808 is completed, processing advances to decision operation 810.

At decision operation 810, a determination is made whether an existing element has been removed. If the decision is affirmative, processing moves to operation 812. Otherwise, processing proceeds to decision operation 814.

At operation 812, an “exclude” process removes the existing element from the scorecard structure and adjusts scorecard hierarchy and calculations accordingly. Processing moves from operation 812 to decision operation 814.

At decision operation 814, a determination is made whether a change has been made to content and/or properties of an existing element. Examples of changes are given above in conjunction with FIG. 6. If a change is made, processing moves to operation 816, where an “update” process updates content and/or properties of the changed element in the new configuration data. Processing then moves to operation 818.

In other embodiments, resolving the differences may further include accepting or rejecting the changes based on subscriber credentials (assigned permission attributes), temporal comparison of the changes from different sources, and the like.

At operation 818, new configuration data is created based on the resolved differences. According to some embodiments, the new configuration data may include indicators for modified elements. Processing advances from operation 818 to optional operation 820.

At optional operation 820, modified elements are flagged to indicate the changes. In a scorecard presentation, modified elements may be highlighted, an alert may be issued to indicate that one or more elements have been changed, and the like. Subscribers may be provided a list of the changes and prompted to accept or reject the changes. After optional operation 820 processing moves to a calling process for further actions.

The operations included in process 800 are for illustration purposes. Disconnected authoring of business definitions may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for disconnected authoring of elements in a business logic application, comprising:
dynamically modifying original configuration information associated with the scorecard in response to a modification of a business scorecard in a disconnected phase;
comparing the modified configuration information to the original configuration information upon transitioning to a connected phase;
resolving differences between the modified configuration information and the original configuration information based on the comparison; and
creating new configuration information based on the resolved differences.

2. The computer-implemented method of claim 1, wherein the configuration information includes at least one of: a scorecard identifier, a business metrics identifier, a data source identifier, and a status indicator.

3. The computer-implemented method of claim 2, wherein the business metrics identifier includes at least one of: a Key Performance Indicator (KPI) identifier, a KPI group identifier, and an objective identifier.

4. The computer-implemented method of claim 2, wherein the configuration information further includes at least one of: content associated with the scorecard and metadata associated with at least one of the elements of the scorecard.

5. The computer-implemented method of claim 1, wherein resolving the differences includes assigning a most recent value for an element from one of the modified configuration information and the original configuration information to the corresponding element in the new configuration information.

6. The computer-implemented method of claim 5, wherein resolving the differences further includes accepting modifications in the modified configuration information based on a permission assigned to a subscriber performing the modification.

7. The computer-implemented method of claim 1, wherein the configuration information is maintained in a versioned eXtensible Mark-up Language (XML) file.

8. The computer-implemented method of claim 1, further comprising saving the modified configuration information upon at least one of: expiration of a predetermined period, completion of the modification, and start of a transitioning process to the reconnected phase.

9. The computer-implemented method of claim 1, further comprising issuing an alert to selected subscribers when the original configuration information is updated based on the modified configuration information.

10. The computer-implemented method of claim 1, wherein resolving the differences includes at least one of a create process, an exclude process, and an update process.

11. The computer-implemented method of claim 10, wherein the create process includes adding a new element from a subscriber workspace to the scorecard based on the modified configuration information.

12. The computer-implemented method of claim 10, wherein the exclude process includes removing an existing element of the scorecard based on the modified configuration information.

13. The computer-implemented method of claim 10, wherein the update process includes updating at least one of content and metadata associated with an existing element of the scorecard based on the modified configuration information.

14. A computer-readable medium having computer instructions for phased authoring of a business scorecard, the instructions comprising:
dynamically modifying configuration data associated with a scorecard element in response to a modification of the scorecard element in a disconnected phase;
comparing the modified configuration data to an original configuration data upon transitioning to a connected phase;
resolving differences between the modified configuration data and the original configuration data based on the comparison; and
creating new configuration data for the scorecard element based on the resolved differences.

15. The computer-readable medium of claim 14, further comprising providing a modification indicator for the modified scorecard element in a scorecard presentation during the reconnected phase.

16. The computer-readable medium of claim 14, wherein resolving the differences includes at least one of: creating a new scorecard element from a subscriber workspace, excluding an existing scorecard element from the scorecard, and updating content and metadata associated with an existing scorecard element based on the modification to the scorecard element during the disconnected phase.

17. A system for phased authoring of a business scorecard application, the system comprising:
a server application configured to:
receive modified configuration data associated with a scorecard element upon transitioning to a reconnected phase;
compare the modified configuration data to an original configuration data associated with the scorecard element;
resolve differences between the modified configuration data and the original configuration data based on the comparison; and
create new configuration data for the scorecard element based on the resolved differences; and
a client application configured to:
provide a user interface for authoring the scorecard in a disconnected phase; and
provide the modified configuration data to the server application upon transitioning to the reconnected phase.

18. The system of claim 17, wherein the server application is further configured to resolve the differences by assigning a most recent value for the scorecard element from one of the modified configuration data and the original configuration data to the corresponding scorecard element in the new configuration information.

19. The system of claim 17, wherein the server application and the client application are configured to maintain configuration data in form of versioned XML files.

20. The system of claim 17, wherein the server application is further configured to resolve the differences by at least one of: creating a new scorecard element from a subscriber workspace, excluding an existing scorecard element from the scorecard, and updating content and metadata associated with an existing scorecard element based on the modification to the scorecard element during the disconnected phase.
